(19) United States
(12) Patent Application Publication
(10) Pub. No.: US 2026/0095506 A1
(43) Pub. Date: Apr. 2, 2026

(54) ACCESSING DATA IN A CLOUD STORAGE ARCHITECTURE USING A MULTI-LAYERED CACHED BITMAP

(71) Applicant: International Business Machines Corporation, Armonk, NY (US)

(72) Inventors: Sanket Bhaskar Pachpor, Pune (IN); Kushal Sanjivkumar Patel, Pune (IN); Sarvesh Sanjeev Patel, Pune (IN)

(21) Appl. No.: 18/900,782

(22) Filed: Sep. 29, 2024

(51) Int. Cl. H04L 67/1097; H04L 67/2885; H04L 67/61

(52) U.S. Cl. CPC H04L 67/1097; H04L 67/2885; H04L 67/61

(57) ABSTRACT

A computer-implemented method, system, and computer program product for improving utilization of cloud storage resources is disclosed. Upon the storage of new data in a storage block of the cloud storage architecture, the location of the new data is recorded in a bitmap stored across multiple cache layers located at different hops from the information sender. The flag in the bitmap associated with the newly stored data is set to a first value upon the recording of the location of the new data and data synchronization is started. Upon the completion of data synchronization, the flag in the bitmap is set to a second value. By setting the flag to a second value, the requested data will be obtained from a cache at a particular cache layer.

### BACKGROUND

The present disclosure relates generally to a cloud storage architecture, and more particularly to accessing data in a cloud storage architecture using a multi-layered cached bitmap thereby improving bandwidth and network traffic utilization and kernel efficiency.

A cloud storage architecture involves the design and arrangement of components to provide scalable, reliable, and secure storage services in a cloud computing environment. In particular, a cloud storage architecture is designed to provide a scalable, reliable, and secure foundation for storing and retrieving data in a cloud environment. Specific implementations may vary based on the cloud service provider and the type of storage service offered (e.g., object storage, file storage, block storage).

### SUMMARY

In one embodiment of the present disclosure, a computer-implemented method for improving utilization of cloud storage resources comprises recording a location of new data written in a storage block of a cloud storage architecture in a bitmap, where the bitmap is stored across multiple cache layers located at different hops from an information sender. The method further comprises setting a flag in the bitmap to a first value. The method additionally comprises performing data synchronization in response to the new data being written in the storage block of the cloud storage architecture. Furthermore, the method comprises setting the flag in the bitmap to a second value in response to completing the data synchronization between caches of the multiple cache layers located at different hops from the information sender and the storage block of the cloud storage architecture.

Other forms of the embodiment of the computer-implemented method described above are in a system and in a computer program product.

The foregoing generally outlines the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components used by the storage controller for improving the utilization of cloud storage resources by efficiently accessing data in the cloud storage environment in accordance with an embodiment of the present disclosure;

FIG. 3 illustrates an embodiment of the present disclosure of the hardware configuration of the storage controller which is representative of a hardware environment for practicing the present disclosure;

FIG. 4 is a flowchart of a method for synchronizing data in accordance with an embodiment of the present disclosure;

FIG. 5 is a flowchart of a method for improving the utilization of the cloud storage resources by efficiently accessing data in the cloud storage environment in accordance with an embodiment of the present disclosure; and

FIG. 6 is a flowchart of a method for coordinating which hop caches will service the queries/requests issued from the applications of particular user groups in accordance with an embodiment of the present disclosure.

### DETAILED DESCRIPTION

As stated above, a cloud storage architecture involves the design and arrangement of components to provide scalable, reliable, and secure storage services in a cloud computing environment. In particular, a cloud storage architecture is designed to provide a scalable, reliable, and secure foundation for storing and retrieving data in a cloud environment. Specific implementations may vary based on the cloud service provider and the type of storage service offered (e.g., object storage, file storage, block storage).

Typically, in a cloud storage architecture, a request, such as a request to read or write data, from an application of a user is received by a server, and a network adapter of the server is used to connect the application of the user to the storage devices (e.g., database warehouse) of the cloud storage architecture. For example, such a network adapter may correspond to a host bus adapter corresponding to a circuit board or integrated circuit adapter, where the network adapter enables input/output (I/O) processing and provides a physical connection between the server or host I/O bus and the storage devices of the cloud storage architecture. In another example, such a network adapter may correspond to a converged network adapter which provides connectivity and data transfer between the applications of the users and the storage devices of the cloud storage architecture as well as directly delivers Ethernet traffic from network devices.

Such network adapters may be connected to the storage devices of the cloud storage architecture via a switched fabric. That is, the requests from the applications of the users may be provided to a switched fabric, and the switched fabric forwards such requests to a storage controller configured to control the storage and retrieval of data from the cloud storage architecture. A switched fabric corresponds to a network topology in which network nodes interconnect via one or more network switches (particularly crossbar switches). Because a switched fabric network spreads network traffic across multiple physical links, it yields higher total throughput than broadcast networks.

Once the request is received by the storage controller, the kernel (core of the storage controller's operating system) searches for the requested data block from the storage pool of the cloud storage architecture. A storage pool is a collection of physical storage devices that are aggregated together to create a shared storage environment.

Such a data block may be identified via a logical block address, which is a unique address assigned to each block of data stored in the storage devices of the cloud storage architecture. Because there are a great number of logical block addresses, the searching performed by the kernel to identify the correct block of data to retrieve the requested data is extensive.

Unfortunately, in such a process for retrieving data from a cloud storage architecture, resources (e.g., kernel operations), bandwidth, and network traffic may be inefficiently utilized. For example, if an application of a user requests a bank balance stored on a storage device of the cloud storage architecture, the request will travel the path discussed above to query the storage device for the requested data. For example, the kernel of the storage controller will obtain the requested data from the appropriate storage device of the cloud storage architecture and respond to the query informing the application of the user of the current bank balance via the components (e.g., server and switched fabric) discussed above. If the application of the user reiterates the same request, such as within a short period of time in which the bank balance has not been updated, the above-described process is repeated, including the kernel operations, bandwidth utilization, and network traffic discussed above, and the application of the user will receive the same response. Despite the fact that there is no change in the requested data, the kernel, bandwidth, and network traffic are still utilized in the same manner which results in an inefficient utilization of the bandwidth, network traffic, and kernel operations. For example, the bandwidth, network traffic, and kernel operations could have been utilized for other productive purposes. For instance, the bandwidth, network traffic, and kernel operations could have been utilized to service other requests during this period of time. As a result of not being able to service such requests during that period of time, the time to service such requests may be increased.

Embodiments of the present disclosure offer a means for efficiently accessing data in a cloud storage environment.

The embodiments of the present disclosure provide a means for improving the utilization of the cloud storage resources by efficiently accessing data in the cloud storage environment. In one embodiment, a bitmap is stored across multiple cache layers located at different hops in the cloud topology from an information sender. A bitmap, as used herein, is a type of memory organization used to store the locations of the data written in the storage blocks of the cloud storage architecture as well as stores flags associated with such data which indicate whether such data is synchronized (i.e., data stored in the storage block of the cloud storage architecture is replicated in the caches across the cache layers). A flag, as used herein, refers to one or more bits that are used to store a binary value signaling whether the associated data has been synchronized. The bitmap stores the locations of the data written in the storage blocks of the cloud storage architecture as well as flags associated with the stored data which indicate whether the data is synchronized (i.e., the data stored in the storage block of the cloud storage architecture is replicated in the caches of the cache layers). A cache layer, as used herein, is a component in the software system that temporarily stores a copy of the data stored in the storage block of the cloud storage architecture. A hop in the cloud topology, as used herein, refers to a portion of the network path between the information sender (application of the user issuing a query to request data) and the receiver (e.g., storage controller).

In some embodiments, a flag in the bitmap associated with the new data written in the storage block of the cloud storage architecture is set to a first value (e.g., value of 1) in response to writing the new data in the storage block of the cloud storage architecture. Setting the flag to a first value indicates that the written data is being synchronized with the caches of the cache layers. Upon completion of the data synchronization between the caches of the cache layers located at different hops in the cloud topology from the information sender and the storage block of the cloud storage architecture, the flag is set to a second value (e.g., value of 0). Data synchronization, as used herein, refers to the process of establishing consistency between the source (e.g., data stored in the storage block of the cloud storage architecture) and the target (e.g., caches across the cache layers). Upon setting the value of the flag to the second value, the associated data may then be provided from the caches of a particular cache layer located at a particular hop in the cloud topology from the information sender as opposed to the target storage block in the cloud storage architecture in response to receiving a request to access such data. By accessing the requested data from the caches as opposed to the target storage block in the cloud storage architecture, the utilization of the kernel operations, bandwidth, and network traffic will be lessened. For example, the kernel of the storage controller will no longer need to be utilized to search for the requested data block from the storage pool of the cloud storage architecture. Furthermore, the utilization of the bandwidth and network traffic will be lessened because fewer hops in the cloud topology will need to be utilized to access the requested data.

Additionally, in one embodiment, the requested data is retrieved from the caches at a particular cache layer located at a particular hop in the cloud topology from the information sender based on the priority of the user. As a result, higher priority users may access the data more quickly than lower priority users by being able to access the requested data stored in the caches of a cache layer located at a fewer number of hops in the cloud topology from the information sender. Lower priority users may access the requested data stored in the caches of a cache layer located at a greater number of hops in the cloud topology from the information sender. As a result, bandwidth and network traffic utilization is improved while the kernel operates more efficiently in connection with accessing data stored in the cloud storage architecture. These and other features will be discussed in further detail below.

In some embodiments of the present disclosure, the present disclosure comprises a computer-implemented method, system, and computer program product for improving utilization of cloud storage resources. In one embodiment of the present disclosure, upon the storage of new data in a storage block of the cloud storage architecture, the location of the new data written in the storage block of the cloud storage architecture is recorded in a bitmap, and the bitmap is stored across multiple cache layers located at different hops from the information sender.

In some embodiments of the present disclosure, the flag in the bitmap associated with the data being stored in the storage block of the cloud storage architecture is set to a first value (e.g., value of 1). Data synchronization is started upon the recording of the location of the new data written in the storage block of the cloud storage architecture. By setting the flag associated with the new data written in the storage block of the cloud storage architecture to a first value (e.g., value of 1), the request to access the data will move forward to the kernel to be handled by the kernel. Upon the completion of the data synchronization, the flag in the bitmap associated with the new data written in the storage block of the cloud storage architecture is set to a second value (e.g., value of 0). By setting the flag to a second value (e.g., value of 0), the requested data will be obtained from a cache at a particular cache layer as opposed to being handled by the kernel; this reduces the utilization of the bandwidth and network traffic and reduces the operation of the kernel. In this manner, the present application offers improvements to bandwidth and network traffic utilization as well as to kernel operation efficiency, particularly kernel operation efficiency with respect to accessing data stored in the cloud storage architecture.

In the following description, numerous specific details are set forth to provide a thorough understanding of the present disclosure; it will be apparent to those skilled in the art that the present disclosure may be practiced without these specific details. In some instances, well-known circuits have been shown in block diagram form in to obscure the present disclosure in unnecessary detail. Details considering timing considerations and the like have been generally omitted inasmuch as such details are not necessary to obtain a complete understanding of the present disclosure and are within the skills of persons of ordinary skill the relevant art.

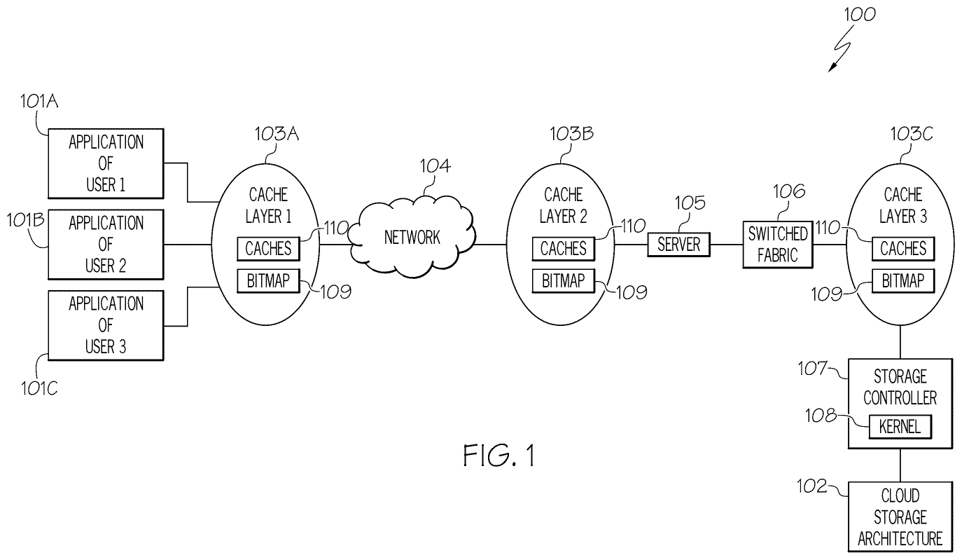

Referring now to the figures, FIG. 1 illustrates an embodiment of the present disclosure of a communication system 100 for practicing the principles of the present disclosure. The communication system 100 includes the applications 101A-101C of users (identified as “Application of User 1,” “Application of User 2,” and “Application of User 3,” respectively, in FIG. 1) connected to a cloud storage architecture 102 via the cache layers 103A-103C (identified as “Cache Layer 1,” “Cache Layer 2,” and “Cache Layer 3,” respectively, in FIG. 1), network 104, server 105, switched fabric 106, and storage controller 107. The applications 101A-101C of users may collectively or individually be referred to as the applications 101 of users or an the application 101 of a user. Furthermore, the cache layers 103A-103C may collectively or individually be referred to as the cache layers 103 or the cache layer 103, respectively.

The application 101 of a user, as used herein, refers to an application that is utilized by a user, such as via the user's computing device (e.g., portable computing unit, Personal Digital Assistant (PDA), laptop computer, mobile device, tablet personal computer, smartphone, mobile phone, navigation device, gaming unit, desktop computer system, workstation, and the like). The application may be configured to issue a query requesting data, such as data stored in the cloud storage architecture 102. Examples of such applications include transaction applications, gaming applications, database applications, simulation applications, etc.

The cloud storage architecture 102, as used herein, refers to the design and arrangement of components that provide scalable, reliable, and secure storage services in a cloud computing environment. In particular, the cloud storage architecture 102 is designed to provide a scalable, reliable, and secure foundation for storing and retrieving data in a cloud environment. Specific implementations may vary based on the cloud service provider and the type of storage service offered (e.g., object storage, file storage, or block storage).

In some embodiments, the cloud storage architecture 102 may include databases such as a cloud database. A cloud database is a database that is built and managed in a cloud environment such as a private, public, or hybrid cloud environment. It allows organizations to store, organize, and manage data over the Internet rather than on a physical server on-premises. An example of a cloud database is a remote cloud database. A remote cloud database is a database that is hosted and managed in the cloud, allowing users to access data from anywhere with an Internet connection. This feature allows users to interact with the database of cloud storage architecture 102 from various devices and operating systems.

In some embodiments, the cloud storage architecture 102 may include a database warehouse. A database warehouse is a type of data management system that is designed to enable and support business intelligence (BI) activities, especially analytics. Data warehouses may be used to perform queries and analysis and contain large amounts of historical data. In some embodiments, the data within a data warehouse may be derived from a wide range of sources such as application log files and transaction applications.

In some embodiments, the cloud storage architecture 102 may include a local file system. A local file system is a storage model that manages files on a single machine and stores data in a single block.

In some embodiments, a request, such as a request to access data, from the application 101 of a user may be received by a server 105 via a network 104, and a network adapter of the server 105 is used to connect the application 101 of the user to the storage devices (e.g., database warehouse) of the cloud storage architecture 102. For example, such a network adapter may correspond to a host bus adapter corresponding to a circuit board or integrated circuit adapter; the circuit board or integrated circuit adapter may enable input/output (I/O) processing and provide a physical connection between the server 105 or host I/O bus and the storage devices of the cloud storage architecture 102. In another example, such a network adapter may correspond to a converged network adapter which provides connectivity and data transfer between the applications 101 of the users and the storage devices (e.g., data warehouse) of the cloud storage architecture 102 as well as directly delivers Ethernet traffic from network devices.

Network adapters may be connected to the storage devices (e.g., cloud database) of the cloud storage architecture 102 via a switched fabric 106. That is, the requests from the applications 101 of the users may be provided to the switched fabric 106 which forwards such requests to a storage controller 107 configured to control the storage and retrieval of data from the cloud storage architecture 102. The switched fabric 106, as used herein, corresponds to a network topology in which network nodes interconnect via one or more network switches (particularly crossbar switches). Because a switched fabric network spreads network traffic across multiple physical links, it yields higher total throughput than broadcast networks.

In one embodiment, various elements of the communication system 100, such as the cache layers 103A, 103B, are connected to each other via a network 104, which is responsible for enabling the transmission and exchange of information and resources. The network 104 may be, for example, a local area network, a wide area network, a wireless wide area network, a circuit-switched telephone network, a Global System for Mobile communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with the system 100 of FIG. 1 without departing from the scope of the present disclosure.

As discussed above, the storage controller 107 is configured to control the storage and retrieval of data from the cloud storage architecture 102. In some embodiments, once a request to access data from the cloud storage architecture 102 is received from the application 101, the kernel 108 (core of the storage controller's operating system) of the storage controller 107 searches for the requested data block from the storage pool of the cloud storage architecture 102. A storage pool, as used herein, refers to the collection of physical storage devices (e.g., cloud database, data warehouse, and/or local file system) that are aggregated together to create a shared storage environment.

In some embodiments, the data blocks stored in the storage pool of cloud storage architecture 102 are identified via a logical block address. A logical block address is a unique address assigned to each block of data stored in the storage devices of the cloud storage architecture 102. As previously discussed, the searching performed by the kernel 108 to identify the correct block of data to retrieve the requested data is extensive because there are a great number of logical block addresses. The principles of the present disclosure enable such kernel operations to be more efficiently utilized as discussed further below.

In some embodiments, the storage controller 107 may be configured to efficiently access data stored in the cloud storage architecture 102 in a manner that improves the utilization of bandwidth and network traffic as well as improves the efficiency of the kernel 108 operations by using a bitmap 109 stored across multiple cache layers 103 located at different hops in the cloud topology from the information sender as depicted in FIG. 1. A cache 110, as used herein, refers to a component (e.g., hardware or software component) that stores data so that future requests for that data can be served faster.

In some embodiments, the information sender may be the application 101 of the user issuing a query to request data and the receiver may be the storage controller 107. For example, in FIG. 1, the cache layer 103A is located at a first hop from the information sender (e.g., application 101), the cache layer 103B is located at a second hop from the information sender, and the cache layer 103C is located at a third hop from the information sender.

In some embodiments, the storage controller 107 sets a flag in the bitmap 109 associated with the new data written in the storage block of the cloud storage architecture 102 to a first value (e.g., value of 1) and starts data synchronization (i.e., the new data stored in the storage block of the cloud storage architecture 102 is replicated in the caches 110 of the cache layers 103) in response to writing the new data in the storage block of the cloud storage architecture 102. Setting the flag to a first value indicates that the written data is being synchronized with the caches 110 of the cache layers 103.

In some embodiments, upon the completion of the data synchronization between the caches 110 of the cache layers 103 and the storage block of the cloud storage architecture 102, the storage controller 107 sets the flag associated with the synchronized data to a second value (e.g., value of 0). Upon setting the value of the flag to the second value, the associated data may then be provided from the caches 110 of a particular cache layer (e.g., cache layer 103A) located at a particular hop (e.g., first hop) in the cloud topology from the information sender (e.g., application 101) as opposed to the target storage block in the cloud storage architecture 102 in response to receiving a request to access such data by the application 101.

The utilization of the kernel operations, bandwidth, and network traffic are lessened by accessing the requested data from the caches 110 instead of accessing the target storage block in the cloud storage architecture 102. For example, the kernel 108 of the storage controller 107 no longer needs to search for the requested data block from the storage pool of the cloud storage architecture 102. Furthermore, the utilization of the bandwidth and network traffic is lessened because fewer hops in the cloud topology are needed to access the requested data. Additionally, in some embodiments, the requested data is retrieved from the caches 110 of a particular cache layer 103 located at a particular hop (e.g., first hop) in the cloud topology from the information sender based on the priority of the user.

The system 100 is not to be limited in scope to any one particular network architecture. The system 100 may include any number of applications 101, cloud storage architectures 102, cache layers 103, networks 104, servers 105, switched fabrics 106, storage controllers 107, kernels 108, bitmaps 109, and caches 110.

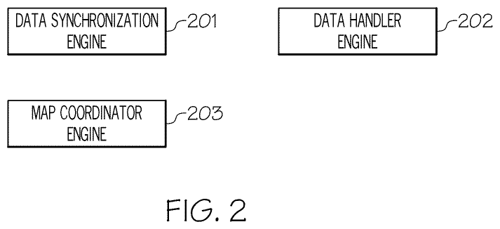

A further discussion regarding the storage controller 107 that improves the utilization of bandwidth and network traffic as well as improves the efficiency of the operations of the kernel 108 is provided below in connection with FIGS. 2 and 4-6.

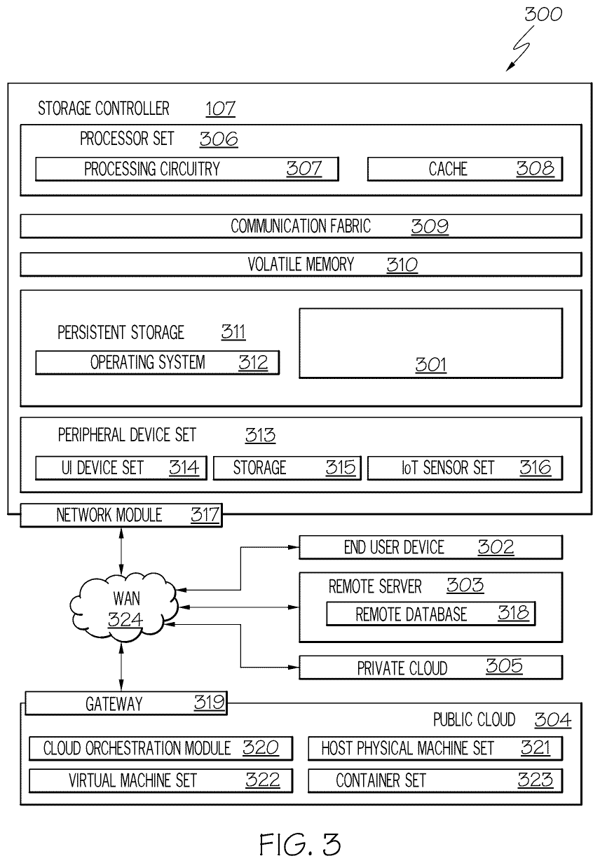

The present disclosure provides a description of the software components of the storage controller 107 in connection with FIG. 2 and a description of the hardware configuration of the storage controller 107 in connection with FIG. 3.

FIG. 2 is a diagram of the software components used by the storage controller 107 to improve the utilization of cloud storage resources by efficiently accessing data in the cloud storage environment (e.g., cloud storage architecture 102) in accordance with an embodiment of the present disclosure.

Referring to both FIG. 1 and FIG. 2, the storage controller 107 includes a data synchronization engine 201. The data synchronization engine 201 is configured to synchronize data between the caches 110 of the cache layers 103 located at different hops from the information sender (e.g., application 101) and the storage block of the cloud storage architecture 102. As discussed above, data synchronization, as used herein, refers to the process of establishing consistency between the source (e.g., data stored in the storage block of the cloud storage architecture 102) and the target (e.g., the caches 110 of the cache layers 103). The data synchronization engine 201 utilizes various tools for performing such data synchronization, which can include, but are not limited to, data replication (including real-time data replication between heterogeneous data stores) tools, distributed event store and stream-processing platforms, data integration platforms, extract, transform, and load (ETL) tools, and the like.

In some embodiments, data is broken into blocks, and the data synchronization engine 201 monitors the storage of new data in storage blocks of the cloud storage architecture 102. In some embodiments, the data synchronization engine 201 utilizes various tools for performing such monitoring, which can include, but are not limited to, artificial intelligence, analytics and automation platforms, observability services for cloud-scale applications, application performance management software, information technology operations analytics programs, machine-generated data software, and the like.

In some embodiments, upon the storage of new data in a storage block of the cloud storage architecture 102, the data synchronization engine 201 records the location of the new data written in the storage block of the cloud storage architecture 102 in the bitmap 109. The bitmap 109 is stored across multiple cache layers 103 located at different hops from the information sender (e.g., application 101).

In some embodiments, the data synchronization engine 201 is configured to set a flag associated with the data being stored in the storage block of the cloud storage architecture 102 in the bitmap 109 to a first value (e.g., value of 1) upon the recording of the location of the new data written in the storage block of the cloud storage architecture 102. In some embodiments, the flag is associated with the data being stored in the storage block of the cloud storage architecture 102 based on an identifier that identifies the storage block. The identifier may be a unique identifier that is stored in a data lookup table, and the lookup table may reside within the storage device of the storage controller 107. In some embodiments, the identifier of the data may be stored in the bitmap 109 associated with a particular flag. In some embodiments, the unique identifier may be generated by the data synchronization engine 201 using various tools, such as a version 4 universally unique identifier (UUID4), edwingeng/wuid, etc.

In some embodiments, by setting the flag associated with the new data written in the storage block of the cloud storage architecture 102 to a first value (e.g., value of 1), the request to access the data moves forward to the kernel 108 of the storage controller 107. Otherwise, the requested data would need to be obtained from the cache 110 at a particular cache layer 103 as discussed further below.

The data synchronization engine 201 is configured to start synchronizing data between the storage block of the cloud storage architecture 102 where the new data was stored and the caches 110 of the multiple cache layers 103 located at different hops from the information sender (e.g., application 101). The data synchronization engine 201 may start upon the recording of the location of the new data written in the storage block of the cloud storage architecture 102. In some embodiments, the data stored in the storage block of the cloud storage architecture 102 is replicated in the caches 110 across the multiple cloud layers 103 so that such data can be obtained at a particular cache layer 103 based on the priority of the user.

Upon the completion of the data synchronization), the data synchronization engine 201 sets the flag associated with the new data written in the storage block of the cloud storage architecture 102 to a second value (e.g., value of 0).

The storage controller 107 further includes a data handler engine 202. In some embodiments, the data handler engine 202 is configured to identify the priority of the user. In some embodiments, the data handler engine 202 identifies the priority of the user based on performing a look-up in a data structure (e.g., table) that contains a listing of priorities associated with the users of the applications 101. In some embodiments, the data handler engine 202 may identify the user of the application 101 based on the system log of the computing device. In some embodiments, the data handler engine 202 may identify the user of the application 101 based on the login identifier and password used by the user to access the communication system 100. In some embodiments, the data handler engine 202 may identify the user of the application 101 based on identifying the signed-in user of the computing device. In some embodiments, the data structure storing a listing of priorities associated with the users of the applications 101 may be populated by an expert, e.g., developer. In some embodiments, the data structure may reside within the storage device of the storage controller 107.

A user group, as used herein, refers to a group of users who are all assigned a particular priority. Examples of user groups include an administrative group, domain users, enterprise administrators, guests, users, etc. In some embodiments, the data handler engine 202 determines the group associated with the user based on a data structure (e.g., table) which stores a listing of groups and the users of such groups. Upon identifying the user of the application 101, the group associated with the user may be identified from the a data structure. In one embodiment, the data structures discussed above are populated by an expert. In some embodiments, the data structures reside within the storage device of the storage controller 107.

In some embodiments, the data handler engine 202 is configured to identify the flag associated with the requested data from the bitmap 109 of the cache layer 103 located at a particular hop in the cache topology from the information sender associated with the priority of the user. As previously discussed, the data stored in the storage blocks of the cloud storage architecture 102 are each associated with an identifier, and the identifiers are stored in a data lookup table of data and their associated identifiers. The lookup table may reside within the storage device of the storage controller 107. Upon obtaining the identifier of the requested data from the data lookup table, the data handler engine 202 may identify the flag associated with the requested data based on identifying the flag associated with the identifier stored in the bitmap 109.

In some embodiments, based on the priority of the user, the data handler engine 202 identifies the flag from the bitmap 109 of the cache layer 103 located at the particular hop in the cloud topology associated with the priority of the user. For example, if the user is associated with a user group with the highest priority (e.g., user group #1), then the requests from applications 101 of the user may be serviced from the caches 110 of the cache layer 103A located at the first hop in the cloud topology from the information sender (e.g., application 101). Hence, for a user in a group with the highest priority, the data handler engine 202 may identify the flag from the bitmap 109 of the cache layer 103A located at the first hop in the cloud topology from the information sender (e.g., application 101).

In another example, if a user is associated with a user group with the middle priority (e.g., user group #2), then the requests from applications 101 of the user may be serviced from the caches 110 of the cache layer 103B located at the second hop in the cloud topology from the information sender (e.g., application 101). Hence, for a user in a group with the middle priority, the data handler engine 202 may identify the flag from the bitmap 109 of the cache layer 103B located at the second hop in the cloud topology from the information sender (e.g., application 101).

In a further example, if the user is associated with a user group with the lowest priority (e.g., user group #3), then the requests from the applications 101 of the user may be serviced from the caches 110 of the cache layer 103C located at the third hop in the cloud topology from the information sender (e.g., application 101). Hence, for a user in a group with the lowest priority, the data handler engine 202 may identify the flag from the bitmap 109 of the cache layer 103C located at the third hop in the cloud topology from the information sender (e.g., application 101).

While the principles of the present disclosure are discussed herein in connection with three different user priorities and three cache layers 103 located at three different hops in the cloud topology from the information sender, the principles of the present disclosure may be applied to any number of user priorities and any number of cache layers 103.

Furthermore, the data handler engine 202 is configured to determine if the value of the flag is equal to the second value. If the value of the flag is equal to the second value, then the data handler engine 202 may obtain the requested data from the caches 110 of the cache layer 103 located at a particular hop in the cloud topology from the information sender per the priority group of the user. For example, if the value of the flag is equal to the second value and the user is associated with a user group with the highest priority, then the user may access the requested data quickly via accessing the requested data stored in the caches 110 of the cache layer 103A located at a first hop in the cloud topology from the information sender.

In another example, if the value of the flag is equal to the second value and the user is associated with a user group with a middle priority, then the user may access the requested data in a relatively fast manner by being able to access the requested data stored in the caches 110 of the cache layer 103B located at the second hop in the cloud topology from the information sender.

In a further example, if the value of the flag is equal to the second value and the user is associated with a user group with a lowest priority, then the user may access the requested data in the caches 110 of the cache layer 103C located at the third hop in the cloud topology from the information sender as opposed to having the kernel 108 of the storage controller 107 access the target storage block.

Upon obtaining the requested data from the caches 110 of the cache layer 103 located at a particular hop in the cloud topology from the information sender based on the priority group of the user, the data handler engine 202 may provide the requested data to the application 101 of the user. As a result, higher priority users may access the data more quickly than others via accessing the requested data stored in the caches of a cache layer located at a fewer number of hops in the cloud topology from the information sender. Lower priority users may access the requested data stored in the caches of a cache layer located at a greater number of hops in the cloud topology from the information sender.

If the value of the flag is not equal to the second value, e.g., the value of the flag is equal to the first value, then the data handler engine 202 may be configured to instruct the kernel 108 of the storage controller 107 to capture the requested data from the target storage block of the cloud storage architecture 102. As discussed above, the flag associated with the requested data is set to the first value when such data is in the process of being synchronized. Because the data has not completed synchronization, it has to be captured from the source in order to ensure that the application 101 receives the appropriate data.

In some embodiments, the kernel 108 captures the appropriate data from the appropriate storage block (i.e., the target storage block) of the cloud storage architecture 102 based on performing a lookup in the data lookup table. The data lookup table may reside within the storage device of the storage controller 107, and the storage controller 107 may include a listing of storage blocks and the data stored therein. The stored data may be identified from a portion of the requested data.

Upon capturing the requested data from the target storage block, the kernel 108 of the storage controller 107 may provide the requested data to the application 101 of the user.

As discussed above, based on the priority of the user, such requests from such users are serviced by the caches 110 of the cache layer 103 located at a different hop in the cloud topology from the information sender. In one embodiment, requests from different user groups may be serviced by the caches 110 located at a particular hop in the cloud topology from the information sender based on the utilization of the caches 110 of the cache layer 103 as discussed below.

Storage controller 107 additionally includes a hop coordinator engine 203 configured to coordinate which hop caches will service the queries/requests (e.g., queries requesting data) issued from the applications 101 of particular user groups. “Hop caches,” as used herein, refer to the caches 110 of the cache layer 103 located at a particular hop in the cloud topology from the information sender.

In some embodiments, the hop coordinator engine 203 determines which hop caches will service the requests from the applications 101 of particular user groups based on the priority of the user making the requests as well as the current utilization of the hop caches. Utilization of the hop caches, as used herein, refers to the amount of storage of the hop cache being used to store data.

For example, if the first hop caches are currently servicing requests from all users, including users from user group #1 with the highest priority, users from user group #2 with the second highest priority, and users from user group #3 with the lowest priority, then the hop coordinator engine 203 may determine if the utilization of the first hop caches (e.g., the caches 110 of the cache layer 103A located at the first hop in the cache topology from the information sender) exceeds a threshold value (e.g., 50% of maximum utilization). If the utilization of the first hop caches does not exceed the threshold value, then the hop coordinator engine 203 may continue to monitor the utilization rate to determine if the utilization of the first hop caches exceeds such a threshold value.

If, however, the hop coordinator engine 203 determines that the utilization of the first hop caches exceeds the threshold value (e.g., 50% of maximum utilization), the hop coordinator engine 203 may coordinate the requests from the lowest priority group (in this example, user group #3) to be serviced from the second hop caches (e.g., the caches 110 of the cache layer 103B located at the second hop in the cache topology from the information sender). As a result, the first hop caches (e.g., the caches 110 of the cache layer 103A located at the first hop in the cache topology from the information sender) will be servicing requests from the top two priority groups (in this example, user groups #1 and #2)).

In one embodiment, the hop coordinator engine 203 may determine if the utilization of the first hop caches, which are currently servicing requests from the top two priority groups, exceeds the threshold value (e.g., 50% of maximum utilization) or is below a threshold value (e.g., 15% of maximum utilization). In some embodiments, the hop coordinator engine 203 may continuously monitor the utilization until it exceeds the threshold value (e.g., 50% of maximum utilization) or is below a threshold value (e.g., 15% of maximum utilization).

If the utilization of the first hop caches (e.g., the caches 110 of the cache layer 103A located at the first hop in the cache topology from the information sender) still exceeds the threshold value (e.g., 50% of maximum utilization) after coordinating the requests from the lowest priority group to be serviced from the second hop caches, then the hop coordinator engine 203 coordinates the requests from the lowest priority group to be serviced from the third hop caches (e.g., the caches 110 of the cache layer 103C located at the third hop in the cache topology from the information sender) and also coordinates the requests from the second highest priority group to be serviced from the second hop caches (e.g., the caches 110 of the cache layer 103B located at the second hop in the cache topology from the information sender). As a result, the first hop caches (e.g., the caches 110 of the cache layer 103A located at the first hop in the cache topology from the information sender) will be servicing requests only from the top priority group.

If, however, the utilization of the first hop caches (e.g., the caches 110 of the cache layer 103A located at the first hop in the cache topology from the information sender) is below a threshold value (e.g., 15% of maximum utilization), then the hop coordinator engine 203 may coordinate the requests from all of the priority groups (e.g., user groups #1, #2, and #3) to be serviced from the first hop caches (e.g., the caches 110 of the cache layer 103A located at the first hop in the cache topology from the information sender).

In the situation in which the first hop caches (e.g., the caches 110 of the cache layer 103A located at the first hop in the cache topology from the information sender) are servicing requests from the top priority group, the second hop caches (e.g., the caches 110 of the cache layer 103B located at the second hop in the cache topology from the information sender) are servicing requests from the second highest priority group, and the third hop caches (e.g., the caches 110 of the cache layer 103C located at the third hop in the cache topology from the information sender) are servicing requests from the lowest priority group, the hop coordinator engine 203 may determine if the utilization of the first hop caches (e.g., the caches 110 of the cache layer 103A located at the first hop in the cache topology from the information sender) is below a threshold value (e.g., 30% of maximum utilization).

If the utilization of the first hop caches is not below a maximum threshold value, then the hop coordinator engine 203 continues to monitor the utilization rate and determine if the utilization of the first hop caches is below the maximum threshold value. If, however, the utilization of the first hop caches is below the maximum threshold value, then the hop coordinator engine 203 coordinates the requests from the second highest priority group to be serviced from the first hop caches and the requests from the lowest priority group to be serviced from the second hop caches. As a result, the first hop caches will service requests from the top two priority groups.

While the foregoing example discusses three priority groups, it is noted that the principles of the present disclosure may be applied to any number of priority groups using the same analysis discussed above.

In some embodiments, the threshold values discussed above may be established by an expert, such as a developer.

The hardware configuration of the storage controller 107 of FIG. 1 is described in connection with FIG. 3. Referring now to FIG. 3, in conjunction with FIG. 1, FIG. 3 illustrates an embodiment of the present disclosure of the hardware configuration of the storage controller 107 which is representative of a hardware environment for practicing the present disclosure.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer readable storage medium, as the term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Computing environment 300 contains an example of an environment for the execution of at least some of the computer code (stored in block 301) involved in performing the inventive methods, such as improving the utilization of cloud storage resources by efficiently accessing data in the cloud storage environment (e.g., cloud storage architecture 102). In addition to block 301, computing environment 300 includes, for example, storage controller 107, network 324 (e.g., network 104 of FIG. 1), such as a wide area network (WAN), end user device (EUD) 302, remote server 303, public cloud 304, and private cloud 305. In this embodiment, storage controller 107 includes processor set 306 (including processing circuitry 307 and cache 308), communication fabric 309, volatile memory 310, persistent storage 311 (including operating system 312 and block 301, as identified above), peripheral device set 313 (including user interface (UI) device set 314, storage 315, and Internet of Things (IoT) sensor set 316), and network module 317. Remote server 303 includes remote database 318. Public cloud 304 includes gateway 319, cloud orchestration module 320, host physical machine set 321, virtual machine set 322, and container set 323.

The storage controller 107 may take the form of a desktop computer, laptop computer, tablet computer, smart phone, smart watch or other wearable computer, mainframe computer, quantum computer, or any other form of computer or mobile device now known or to be developed in the future that is capable of running a program, accessing a network, or querying a database, such as remote database 318. As is well understood in the art of computer technology, and depending upon the technology, performance of a computer-implemented method may be distributed among multiple computers and/or between multiple locations. In this presentation of computing environment 300, detailed discussion is focused on a single computer, specifically the storage controller 107, to keep the presentation as simple as possible. The storage controller 107 may be located in a cloud, even though it is not shown in a cloud in FIG. 3; however, the storage controller 107 is not required to be in a cloud except to any extent as may be affirmatively indicated.

Processor set 306 includes one or more computer processors of any type now known or to be developed in the future. Processing circuitry 307 may be distributed over multiple packages, for example, multiple, coordinated integrated circuit chips. Processing circuitry 307 may implement multiple processor threads and/or multiple processor cores. Cache 308 is memory that is located in the processor chip package(s) and is typically used for data or code that should be available for rapid access by the threads or cores running on processor set 306. Cache memories are typically organized into multiple levels depending upon relative proximity to the processing circuitry. Alternatively, some or all of the cache for the processor set may be located “off chip.” In some computing environments, processor set 306 may be designed for working with qubits and performing quantum computing.

Computer readable program instructions are typically loaded onto the storage controller 107 to cause a series of operational steps to be performed by processor set 306 of the storage controller 107 and thereby effect a computer-implemented method such that the instructions thus executed will instantiate one or more methods specified in flowcharts and/or narrative descriptions of computer-implemented methods included in this document (collectively referred to as “the inventive methods”). These computer readable program instructions are stored in various types of computer readable storage media such as cache 308 and the other storage media discussed below. The program instructions, and associated data, are accessed by processor set 306 to control and direct performance of the inventive methods. In computing environment 300, at least some of the instructions for performing the inventive methods may be stored in block 301 in persistent storage 311.

Communication fabric 309 is the signal conduction paths that allow the various components of the storage controller 107 to communicate with each other. Typically, this fabric is made of switches and electrically conductive paths such as the switches and electrically conductive paths that make up busses, bridges, physical input/output ports, and the like. Other types of signal communication paths may be used such as fiber optic communication paths and/or wireless communication paths.

Volatile memory 310 is any type of volatile memory now known or to be developed in the future. Examples include dynamic type random access memory (RAM) or static type RAM. Typically, the volatile memory is characterized by random access, but this is not required unless affirmatively indicated. In the storage controller 107, the volatile memory 310 is located in a single package and is internal to the storage controller 107, but, alternatively or additionally, the volatile memory may be distributed over multiple packages and/or located externally with respect to the storage controller 107.

Persistent storage 311 is any form of non-volatile storage for computers that is now known or to be developed in the future. The non-volatility of this storage means that the stored data is maintained regardless of whether power is being supplied to the storage controller 107 and/or directly to persistent storage 311. Persistent storage 311 may be a read only memory (ROM), but typically at least a portion of the persistent storage allows writing of data, deletion of data, and re-writing of data. Some familiar forms of persistent storage include magnetic disks and solid state storage devices. Operating system 312 may take several forms, such as various known proprietary operating systems or open source Portable Operating System Interface type operating systems that employ a kernel. The code included in block 301 typically includes at least some of the computer code involved in performing the inventive methods.

Peripheral device set 313 includes the set of peripheral devices of the storage controller 107. Data communication connections between the peripheral devices and the other components of the storage controller 107 may be implemented in various ways, such as Bluetooth® connections, Near-Field Communication (NFC) connections, connections made by cables (such as universal serial bus (USB) type cables), insertion type connections (for example, secure digital (SD) card), connections made though local area communication networks, and even connections made through wide area networks such as the internet. In various embodiments, UI device set 314 may include components such as a display screen, speaker, microphone, wearable devices (such as goggles and smart watches), keyboard, mouse, printer, touchpad, game controllers, and haptic devices. Storage 315 is external storage, such as an external hard drive, or insertable storage, such as an SD card. Storage 315 may be persistent and/or volatile. In some embodiments, storage 315 may take the form of a quantum computing storage device for storing data in the form of qubits. In embodiments where the storage controller 107 is required to have a large amount of storage (for example, where the storage controller 107 locally stores and manages a large database), this storage may be provided by peripheral storage devices designed for storing very large amounts of data, such as a storage area network (SAN) that is shared by multiple, geographically distributed computers. IoT sensor set 316 is made up of sensors that can be used in Internet of Things applications. For example, one sensor may be a thermometer and another sensor may be a motion detector.

Network module 317 is the collection of computer software, hardware, and firmware that allows the storage controller 107 to communicate with other computers through WAN 324. Network module 317 may include hardware such as modems or Wi-Fi signal transceivers, software for packetizing and/or de-packetizing data for communication network transmission, and/or web browser software for communicating data over the internet. In some embodiments, network control functions and network forwarding functions of network module 317 are performed on the same physical hardware device. In other embodiments (for example, embodiments that utilize software-defined networking (SDN)), the control functions and the forwarding functions of network module 317 are performed on physically separate devices such that the control functions manage several different network hardware devices. Computer readable program instructions for performing the inventive methods can typically be downloaded to the storage controller 107 from an external computer or external storage device through a network adapter card or network interface included in network module 317.

WAN 324 is any wide area network (for example, the internet) capable of communicating computer data over non-local distances by any technology for communicating computer data now known or to be developed in the future. In some embodiments, the WAN may be replaced and/or supplemented by local area networks (LANs) designed to communicate data between devices located in a local area such as a Wi-Fi network. The WAN and/or LANs typically include computer hardware such as copper transmission cables, optical transmission fibers, wireless transmission, routers, firewalls, switches, gateway computers, and edge servers.

End user device (EUD) 302 is any computer system that is used and controlled by an end user (for example, a customer of an enterprise that operates a storage controller 107) and may take any of the forms discussed above in connection with storage controller 107. EUD 302 typically receives helpful and useful data from the operations of storage controller 107. For example, in a hypothetical case where the storage controller 107 is designed to provide a recommendation to an end user, this recommendation would typically be communicated from network module 317 of storage controller 107 through WAN 324 to EUD 302. In this way, EUD 302 can display, or otherwise present, the recommendation to an end user. In some embodiments, EUD 302 may be a client device, such as thin client, heavy client, mainframe computer, desktop computer and so on.

Remote server 303 is any computer system that serves at least some data and/or functionality to the storage controller 107. Remote server 303 may be controlled and used by the same entity that operates the storage controller 107. Remote server 303 represents the machine(s) that collect and store helpful and useful data for use by other computers, such as the storage controller 107. For example, in a hypothetical case where the storage controller 107 is designed and programmed to provide a recommendation based on historical data, then this historical data may be provided to the storage controller 107 from remote database 318 of remote server 303.

Public cloud 304 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 304 is performed by the computer hardware and/or software of cloud orchestration module 320. The computing resources provided by public cloud 304 are typically implemented by virtual computing environments that run on various computers making up the computers of host physical machine set 321 which is the universe of physical computers in and/or available to public cloud 304. The virtual computing environments (VCEs) typically take the form of virtual machines from virtual machine set 322 and/or containers from container set 323. It is understood that these VCEs may be stored as images and may be transferred among and between the various physical machine hosts either as images or after instantiation of the VCE. Cloud orchestration module 320 manages the transfer and storage of images, deploys new instantiations of VCEs, and manages active instantiations of VCE deployments. Gateway 319 is the collection of computer software, hardware, and firmware that allows public cloud 304 to communicate through WAN 324.

Some further explanation of virtual computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances called containers. These isolated user-space instances typically behave as real computers from the point of view of programs running in them. A computer program running on an ordinary operating system can utilize all resources of that computer such as connected devices, files and folders, network shares, CPU power, and quantifiable hardware capabilities. However, programs running inside a container can only use the contents of the container and devices assigned to the container, a feature which is known as containerization.

Private cloud 305 is similar to public cloud 304 except that the computing resources are only available for use by a single enterprise. While private cloud 305 is depicted as being in communication with WAN 324 in other embodiments, a private cloud may be disconnected from the internet entirely and only accessible through a local/private network. A hybrid cloud is a composition of multiple clouds of different types (for example, private, community, or public cloud types) often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 304 and private cloud 305 are both part of a larger hybrid cloud.

Block 301 further includes the software components discussed above in connection with FIG. 2 to improve the utilization of cloud storage resources by efficiently accessing data in the cloud storage environment (e.g., cloud storage architecture 102). In some embodiments, such components may be implemented in hardware. The functions discussed above performed by such components are not generic computer functions. As a result, the storage controller 107 is a particular machine that is the result of implementing specific, non-generic computer functions.

In some embodiments, the functionality of such software components of the storage controller 107, including the functionality for improving the utilization of cloud storage resources by efficiently accessing data in the cloud storage environment (e.g., cloud storage architecture 102), may be embodied in an application-specific integrated circuit.

In a cloud storage architecture, a request, such as a request to read or write data, from an application of a user is typically received by a server, and a network adapter of the server is used to connect the application of the user to the storage devices (e.g., database warehouse) of the cloud storage architecture. For example, a network adapter may correspond to a host bus adapter corresponding to a circuit board or integrated circuit adapter, which enables input/output (I/O) processing, and provides a physical connection between the server or host I/O bus and the storage devices of the cloud storage architecture. In another example, a network adapter may correspond to a converged network adapter which provides connectivity and data transfer between the applications of the users and the storage devices of the cloud storage architecture as well as directly delivers Ethernet traffic from network devices.

Network adapters may be connected to the storage devices of the cloud storage architecture via a switched fabric. That is, the requests from the applications of the users may be provided to a switched fabric which forwards the requests to a storage controller configured to control the storage and retrieval of data from the cloud storage architecture. A switched fabric corresponds to a network topology in which network nodes interconnect via one or more network switches (particularly crossbar switches). A switched fabric network yields higher total throughput than broadcast networks because it spreads network traffic across multiple physical links.

Once the request is received by the storage controller, the kernel (core of the storage controller's operating system) searches for the requested data block from the storage pool of the cloud storage architecture. A storage pool is a collection of physical storage devices that are aggregated together to create a shared storage environment. The data block may be identified via a logical block address.

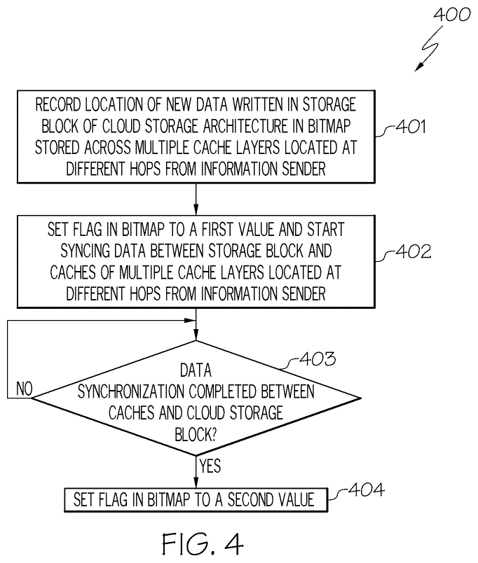

FIG. 4 is a flowchart of a method 400 for synchronizing data in accordance with an embodiment of the present disclosure.

Referring to FIG. 4, in conjunction with FIGS. 1-3, in step 401, upon the storage of new data in a storage block of the cloud storage architecture 102, the data synchronization engine 201 of the storage controller 107 records the location of the new data written in the storage block of the cloud storage architecture 102 in the bitmap 109, which is stored across multiple cache layers 103 located at different hops from the information sender (e.g., application 101).

In step 402, the data synchronization engine 201 of the storage controller 107 sets a flag in the bitmap 109 associated with the data being stored in the storage block of the cloud storage architecture 102 to a first value upon the recording of the location of the new data written in the storage block of the cloud storage architecture 102.

Additionally, in step 402, the data synchronization engine 201 of the storage controller 107 starts synchronizing data between the storage block of the cloud storage architecture 102 where the new data was stored and the caches 110 of the multiple cache layers 103 located at different hops from the information sender (e.g., application 101) upon the recording of the location of the new data written in the storage block of the cloud storage architecture 102. In one embodiment, the data stored in the storage block of the cloud storage architecture 102 is replicated in the caches 110 across the multiple cloud layers 103 so that such data can be obtained at a particular cache layer 103 based on the priority of the user.

In step 403, the data synchronization engine 201 of the storage controller 107 determines whether the data synchronization between the storage block of the cloud storage architecture 102 where the new data was stored and the caches 110 of the multiple cache layers 103 located at different hops from the information sender is completed.

If such data synchronization is not completed, the data synchronization engine 201 continues to determine whether the data synchronization between the storage block of the cloud storage architecture 102 where the new data was stored and the caches 110 of the multiple cache layers 103 located at different hops from the information sender is completed in step 403.

If, however, such data synchronization is completed, then, in step 404, the data synchronization engine 201 of the storage controller 107 sets the flag in the bitmap 109 associated with the new data written in the storage block of the cloud storage architecture 102 to a second value.

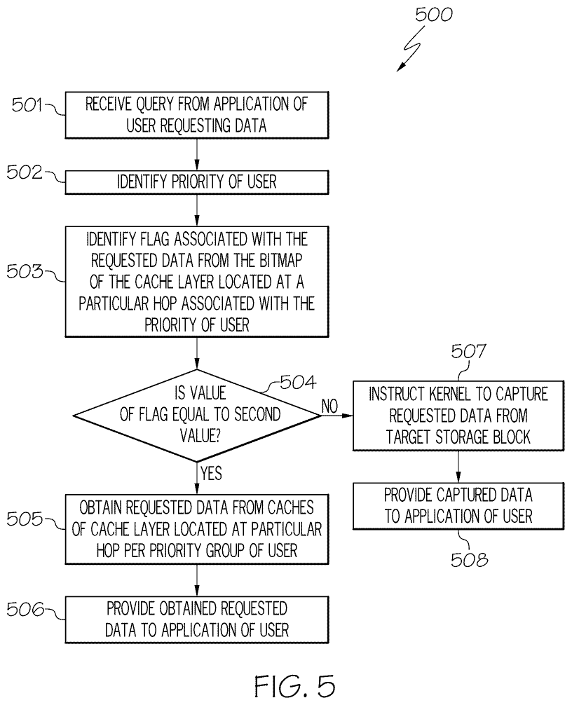

Sata synchronization via the use of setting flags to a particular value to indicate whether data synchronization has been completed may be utilized to improve the utilization of the cloud storage resources by efficiently accessing data in the cloud storage environment as discussed below in connection with FIG. 5.

FIG. 5 is a flowchart of a method 500 for improving the utilization of the cloud storage resources by efficiently accessing data in the cloud storage environment (e.g., cloud storage architecture 102) in accordance with an embodiment of the present disclosure.

Referring to FIG. 5, in conjunction with FIGS. 1-4, in step 501, the data handler engine 202 of the storage controller 107 receives a query from application 101 of a user requesting data.

In step 502, the data handler engine 202 of the storage controller 107 identifies the priority of the user.

In some embodiments, the data handler engine 202 identifies the priority of the user based on performing a look-up in a data structure (e.g., table) that contains a listing of user groups associated with priorities. In one embodiment, the data handler engine 202 determines the group associated with the user based on a data structure (e.g., table) which stores a listing of groups and the users of such groups. Upon identifying the user of the application 101, the group associated with the user is identified from such a data structure. In some embodiments, the data structures discussed above are populated by an expert. In some embodiments, such data structures reside within the storage device (e.g., storage device 311, 315) of the storage controller 107.

In step 503, the data handler engine 202 of the storage controller 107 identifies the flag associated with the requested data from the bitmap 109 of the cache layer 103 located at a particular hop in the cloud topology from the information sender associated with the priority of the user. As previously discussed, the data stored in the storage blocks of the cloud storage architecture 102 are each associated with an identifier. Upon obtaining the identifier, the data handler engine 202 identifies the flag associated with the requested data based on identifying the flag associated with such an identifier stored in the bitmap 109.

In step 504, the data handler engine 202 of the storage controller 107 determines if the value of the flag is equal to the second value.

If the value of the flag is equal to the second value (e.g., value of 0), then, in step 505, the data handler engine 202 of the storage controller 107 obtains the requested data from the caches 110 of the cache layer 103 located at a particular hop in the cloud topology from the information sender (e.g., application 101) per the priority group of the user.

Upon obtaining the requested data from the caches 110 of the cache layer 103 located at a particular hop in the cloud topology from the information sender (e.g., application 101) per the priority group of the user, in step 506, the data handler engine 202 of the storage controller 107 provides the obtained requested data to application 101 of the user.

If, however, the value of the flag is not equal to the second value (e.g., value of 0), i.e., the value of the flag is equal to the first value (e.g., value of 1), then, in step 507, the data handler engine 202 of the storage controller 107 instructs the kernel 108 of the storage controller 107 to capture the requested data from the target storage block of the cloud storage architecture 102.

Upon capturing the requested data from the target storage block, in step 508, the kernel 108 of the storage controller 107 provides the requested data to the application 101 of the user.

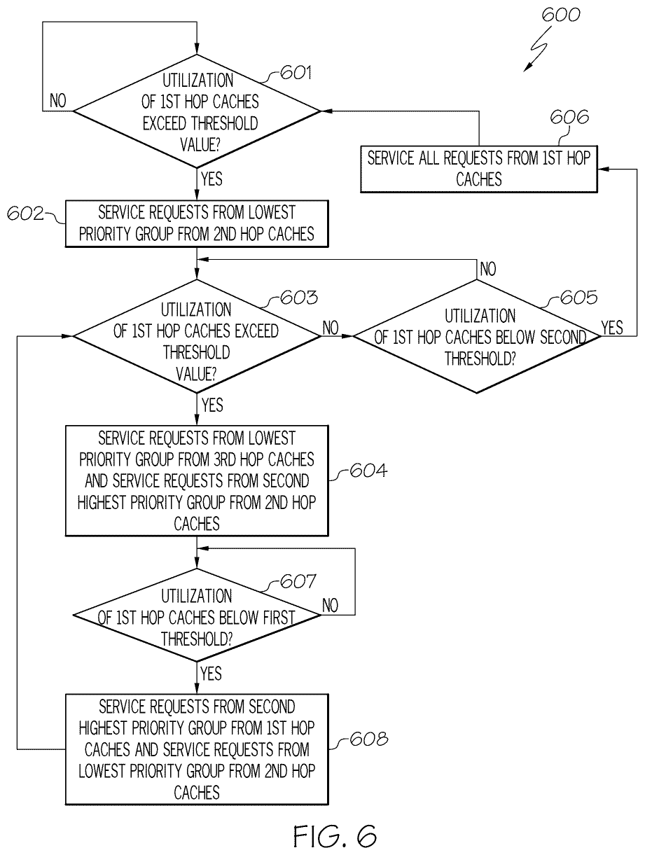

FIG. 6 is a flowchart of a method 600 for coordinating which hop caches will service the queries/requests (queries requesting data) issued from the applications 101 of particular user groups in accordance with an embodiment of the present disclosure.

Referring to FIG. 6, in conjunction with FIGS. 1-5, in step 601, the hop coordinator engine 203 of the storage controller 107 determines if the utilization of the first hop caches (e.g., the caches 110 of the cache layer 103A located at the first hop in the cache topology from the information sender) exceeds a threshold value (e.g., 50% of maximum utilization).

For example, in step 601, if the first hop caches are currently servicing requests from all users in three differently-prioritized user groups, then hop coordinator engine 203 determines if the utilization of the first hop caches exceeds a threshold value.

If the utilization of the first hop caches does not exceed a maximum threshold value, then the hop coordinator engine 203 continues to monitor the utilization rate and determine if the utilization of the first hop caches exceeds the threshold value.

If, however, the hop coordinator engine 203 determines that the utilization of the first hop caches reach a maximum utilization threshold value, then the method 600 proceeds to step 602.

In step 602, the hop coordinator engine 203 of the storage controller 107 coordinates the requests from the lowest priority group to be serviced from the second hop caches. As a result, the first hop caches will be servicing requests from the top two priority groups.

In step 603, the hop coordinator engine 203 of the storage controller 107 determines if the utilization of the first hop caches, which are currently servicing requests from the top two priority groups, exceeds the maximum utilization threshold value. In some embodiments, the hop coordinator engine 203 may continuously monitor the utilization rate until it exceeds a maximum threshold value or falls below a minimum threshold value.

If the utilization of the first hop caches exceeds the maximum utilization threshold value even after coordinating the servicing of requests by another hop cache, then the method 600 proceeds to step 604. In step 604, the hop coordinator engine 203 of the storage controller 107 coordinates the requests from the lowest priority group to be serviced from the third hop caches and coordinates the requests from the second highest priority group to be serviced from the second hop caches. As a result, the first hop caches will only service requests from the top priority group.

If, however, the utilization of the first hop caches does not exceed the maximum utilization threshold value, then the method 600 proceeds to step 605. In step 605, the hop coordinator engine 203 of the storage controller 107 determines if the utilization of the first hop caches (which are currently servicing requests from the top two priority groups) is below a minimum utilization threshold value (e.g., 15% of maximum utilization).

If the utilization of the first hop caches is not below the minimum utilization threshold value, then the method 600 proceeds to step 603. In step 603, the hop coordinator engine 203 determines if the utilization of the first hop caches exceeds the maximum utilization threshold value.

If, however, the utilization of the first hop caches is below a minimum utilization threshold value (e.g., 15% of maximum utilization), then the method 600 proceeds to step 606. In step 606, the hop coordinator engine 203 of the storage controller 107 coordinates all of the requests from all of the priority groups to be serviced from the first hop caches. Upon coordinating the requests from all of the priority groups to be serviced from the first hop caches, the method 600 returns to step 601. In step 601, the hop coordinator engine 203 of the storage controller 107 determines if the utilization of the first hop exceeds a maximum utilization threshold value.

In step 603, the hop coordinator engine 203 determines if the utilization of the first hop caches exceeds the maximum utilization threshold value; if so, the method 600 proceeds to step 604. In step 604, the first hop caches are servicing requests from the top priority group, the second hop caches are servicing requests from the second highest priority group, and the third hop caches are servicing requests from the lowest priority group. The method 600 proceeds to step 607. The hop coordinator engine 203 of the storage controller 107 determines if the utilization of the first hop caches is below a minimum threshold value (e.g., 30% of maximum utilization). In step 607, if the utilization of the first hop caches is not below a minimum threshold value, then the hop coordinator engine 203 continues to monitor the utilization rate and determine whether the utilization of the first hop caches is below the minimum threshold value.

If, however, the utilization of the first hop caches is below a minimum threshold value, then the method 600 proceeds to step 608. In step 608, the hop coordinator engine 203 of the storage controller 107 coordinates the requests from the second highest priority group to be serviced from the first hop caches and the requests from the lowest priority group to be serviced from the second hop caches. As a result, the first hop caches will service requests from the top two priority groups.

Step 608 loops back to step 603 upon the hop coordinator engine 203 coordinating the requests from the second highest priority group to be serviced from the first hop caches and the requests from the lowest priority group to be serviced from the second hop caches. In step 603, the hop coordinator engine 203 determines if the utilization of the first hop caches (which are currently servicing requests from the top two priority groups) exceeds the maximum utilization threshold value.

While the foregoing example discusses three priority groups, it is noted that the principles of the present disclosure may be applied to any number of priority groups using the same analysis discussed above.

The principles of the present disclosure improve the technology or technical field involving a cloud storage architecture. The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for improving utilization of cloud storage resources, the method comprising:
recording a location of new data written in a storage block of a cloud storage architecture in a bitmap, wherein said bitmap is stored across multiple cache layers located at different hops from an information sender;
setting a flag in said bitmap to a first value;
performing data synchronization in response to said new data being written in said storage block of said cloud storage architecture; and
setting said flag in said bitmap to a second value in response to completing said data synchronization between caches of said multiple cache layers located at different hops from said information sender and said storage block of said cloud storage architecture.

2. The method as recited in claim 1 further comprising:
receiving a query requesting data from an application of a user; and
identifying a priority of said user.

3. The method as recited in claim 2 further comprising:
identifying a flag associated with said requested data from said bitmap at a cache layer located at a particular hop from said information sender associated with said priority of said user.

4. The method as recited in claim 3 further comprising:
obtaining said requested data from said cache layer located at said particular hop from said information sender in response to a value of said flag corresponding to said second value; and
providing said obtained requested data to said application of said user.

5. The method as recited in claim 3 further comprising:
capturing said requested data from a target storage block of said cloud storage architecture in response to a value of said flag corresponding to said first value; and
providing said captured requested data to said application of said user.

6. The method as recited in claim 1 further comprising:
servicing requests from applications of users of different priority groups at particular cache layers located at particular hops from said information sender based on utilization of caches across said multiple cache layers.

7. The method as recited in claim 6 further comprising:
comparing a utilization of caches of a particular cache layer located at a particular hop from said information sender to a threshold value to determine which requests from which priority group are to be serviced by said caches of said particular cache layer located at said particular hop from said information sender.

8. A computer program product for improving utilization of cloud storage resources, the computer program product comprising one or more computer readable storage mediums having program code embodied therewith, the program code comprising programming instructions for:
recording a location of new data written in a storage block of a cloud storage architecture in a bitmap, wherein said bitmap is stored across multiple cache layers located at different hops from an information sender;
setting a flag in said bitmap to a first value;
performing data synchronization in response to said new data being written in said storage block of said cloud storage architecture; and
setting said flag in said bitmap to a second value in response to completing said data synchronization between caches of said multiple cache layers located at different hops from said information sender and said storage block of said cloud storage architecture.

9. The computer program product as recited in claim 8, wherein the program code further comprises the programming instructions for:
receiving a query requesting data from an application of a user; and
identifying a priority of said user.

10. The computer program product as recited in claim 9, wherein the program code further comprises the programming instructions for:
identifying a flag associated with said requested data from said bitmap at a cache layer located at a particular hop from said information sender associated with said priority of said user.

11. The computer program product as recited in claim 10, wherein the program code further comprises the programming instructions for:
obtaining said requested data from said cache layer located at said particular hop from said information sender in response to a value of said flag corresponding to said second value; and
providing said obtained requested data to said application of said user.

12. The computer program product as recited in claim 10, wherein the program code further comprises the programming instructions for:
capturing said requested data from a target storage block of said cloud storage architecture in response to a value of said flag corresponding to said first value; and
providing said captured requested data to said application of said user.

13. The computer program product as recited in claim 8, wherein the program code further comprises the programming instructions for:
servicing requests from applications of users of different priority groups at particular cache layers located at particular hops from said information sender based on utilization of caches across said multiple cache layers.

14. The computer program product as recited in claim 13, wherein the program code further comprises the programming instructions for:
comparing a utilization of caches of a particular cache layer located at a particular hop from said information sender to a threshold value to determine which requests from which priority group are to be serviced by said caches of said particular cache layer located at said particular hop from said information sender.

15. A system, comprising:
a memory for storing a computer program for improving utilization of cloud storage resources; and
a processor connected to the memory, wherein the processor is configured to execute program instructions of the computer program comprising:
recording a location of new data written in a storage block of a cloud storage architecture in a bitmap, wherein said bitmap is stored across multiple cache layers located at different hops from an information sender;
setting a flag in said bitmap to a first value;
performing data synchronization in response to said new data being written in said storage block of said cloud storage architecture; and
setting said flag in said bitmap to a second value in response to completing said data synchronization between caches of said multiple cache layers located at different hops from said information sender and said storage block of said cloud storage architecture.

16. The system as recited in claim 15, wherein the program instructions of the computer program further comprise:
receiving a query requesting data from an application of a user; and
identifying a priority of said user.

17. The system as recited in claim 16, wherein the program instructions of the computer program further comprise:
identifying a flag associated with said requested data from said bitmap at a cache layer located at a particular hop from said information sender associated with said priority of said user.

18. The system as recited in claim 17, wherein the program instructions of the computer program further comprise:
obtaining said requested data from said cache layer located at said particular hop from said information sender in response to a value of said flag corresponding to said second value; and
providing said obtained requested data to said application of said user.

19. The system as recited in claim 17, wherein the program instructions of the computer program further comprise:
capturing said requested data from a target storage block of said cloud storage architecture in response to a value of said flag corresponding to said first value; and
providing said captured requested data to said application of said user.

20. The system as recited in claim 15, wherein the program instructions of the computer program further comprise:
servicing requests from applications of users of different priority groups at particular cache layers located at particular hops from said information sender based on utilization of caches across said multiple cache layers.
